(19) United States
(12) Patent Application Publication
(10) Pub. No.: US 2015/0127381 A1
(43) Pub. Date: May 7, 2015

(54) METHOD FOR INTERNET-FACILITATED HEALTH CARE COORDINATION

(71) Applicant: ACCESS TELEHEALTH HOLDINGS, LLC, DENVER, CO (US)

(72) Inventors: Alexander H. Vo, Denver, CO (US); Greg N. Gauthier, Denver, CO (US); Maryann Waugh, Denver, CO (US); Terry A. Mayer, Aurora, CO (US); Jay H. Shore, Denver, CO (US); Marshall R. Thomas, Denver, CO (US)

(21) Appl. No.: 14/532,314

(22) Filed: Nov. 4, 2014

Related U.S. Application Data
(60) Provisional application No. 61/900,177, filed on Nov. 5, 2013.

(51) Int. Cl. G06F 19/00

(52) U.S. Cl. CPC G06F 19/3418; G06F 19/322
USPC 705/3

(57) ABSTRACT

A process that leverages technology to facilitate team-based coordinated care. Techniques for allowing a patient to schedule a future or on-demand videoconference appointment with a health care provider (behavioral or physical), check-in for the appointment, and participate in the videoconference. Further, the system allows a first provider to create and modify in real-time a schedule that modifies availability by types of appointments available and selected by patients/colleagues, view a virtual waiting room in which a patient is virtually located after the patient has checked in, initiate the videoconference, check the availability of a second provider, connect the second provider to the videoconference, view the patient's EHR, add indications about the diagnosis/plan and other notes to the EHR, and generate a bill to the patient for services rendered. Also, the system allows the second provider to indicate their availability, be connected to the videoconference, view the patient's EHR, add indications about the diagnosis/plan and other notes to the EHR, and generate a bill to the patient for services rendered.

### CROSS-REFERENCE TO RELATED APPLICATIONS

This application claims the benefit of U.S. Provisional Patent Application No. 61/900,177, filed on Nov. 5, 2013, the entire contents of which are incorporated herein by reference.

### BACKGROUND

This patent application relates to internet-based telecommunications, or telemedicine, which includes the use of telecommunications technology to provide, enhance, or expedite clinical services.

Telemedicine was developed over forty years ago and was initially used by hospitals tasked with providing care to patients in remote and rural areas. Interest in this field grew substantially during the 1990s and is now becoming a standard part of normal operations in both behavioral and physical health systems of care (Perednia & Allen, 1995). Patient perspective has also been positive. Studies including measures of patient satisfaction cited satisfaction ratings from 85 to 96% which were equal to, or in some cases greater than satisfaction ratings for matched in-patient comparisons. Some hypothesize that assessments and thus treatment decisions may be more accurate when the patient is able to remain in a familiar environment. Examples include observational assessments of emotionally-behaviorally disturbed youth in their typical home/school environment and improved disclosure by adult patients who may provide more honest disclosure while in a more comfortable environment (“Examples of Research Outcomes”, 2013). Telemedicine offers a variety of important benefits to the health care system through improved service access, cost efficacy, and service quality.

A variety of telemedicine inventions have made these health care advances possible. WO 2011/026044 A1, Online Health Service Program and System, details a system for interactive audio, visual, data communication and storage between a patient and health care provider for medical consultation for minor medical conditions. This system included a way for providers to order additional in-person tests and send prescription orders to some pharmacies. US 20110288884A1, Providing Medical Services and/or Products Using Telecommunications, details an internet-based method to log-in online and schedule a provider appointment complete with real-time appointment and provider-patient matching, and a virtual waiting room. This method includes the potential to use the system for health payor billing, and retrieval of an electronic health record, but does not detail how this could occur within technological, policy, privacy, and payment conditions. US 20130253339A1, Network-Based Medical Patient Servicing System, establishes processes for electronic patient scheduling for mobile assessment services that allow non-physician assistants to visit patient homes/community locations and collect electronic medical assessment data for review by a distal physician. US 20130275146A1, Connecting Consumers with Service Providers, creates a network-based repository of provider information to enhance consumer choice and provider access as well as link the providers of the patient's care team to discussion boards, and a timeline of the patient's e-interactions with each of the team's providers to reduce service duplication/conflicts.

While a variety of current telemedicine designs and inventions currently exist and, as noted, are both effective and acceptable to patients receiving either behavioral or physical health care, these systems are still part of an inefficient health care system where patient health needs are not comprehensively met. Currently, many primary care providers (PCP) are treating up to one-third of their client load for psychiatric conditions (Faghri, Boisvert, & Faghri, 2010). Research shows that these PCPs are not fully trained to diagnose or treat mental illness and often prescribe psychotropic drugs inappropriately, and/or with limited follow-up regarding efficacy or side effects. Further, mental health and physical issues are still conceptualized as separate, leading doctors and patients to under-estimate the contribution of these mental health symptoms to chronic disease progression (“Integrating mental health”, 2012). Meanwhile, having an onstaff psychiatrist is cost-prohibitive, and referrals to community mental health centers often lead to discontinuity of care with challenges such as payment, wait times, and even stigma impeding patients from successfully accessing this needed care component (Faghri, Boisvert, & Faghri, 2010).

Additionally, physical and behavioral healthcare have historically fallen under disparate payment systems creating a financial obstacle to care integration. As emergent health care policy demands not only parity for physical and behavioral healthcare, but also evidence of health care efficacy and efficiency, however, payers and providers are beginning to overcome these obstacles (https://www.statereforum.org/weekly-insight/connecting-two-worlds-integrating-physical-and-behavioral-health-care). Federal grants and waiver pilot projects are contributing towards a growing evidence base for integrated care which is paving the way for new flexible payment models and creating the need for new methods to support effective and efficient care coordination across physical and behavioral care providers.

Prior inventions have created specific means for the provision of certain components of telehealth under fixed conditions. What is missing is an internet-based and flexible coordinated system to provide comprehensive patient care within the current landscape of changing health care policies regarding data driven care quality and payment and ever changing technology. To provide the highest quality of care at the lowest cost demands a telemedicine system that supports a team-based approach to coordinated physical and mental health care services, through real time access to shared data and assessment, by users across multiple settings. Role-based multi-point access to shared data and services allows for continuity of integrated direct care delivered to patients in mental health, emergency, primary care, home, and other community environments while tracking service provision for changing payment structures.

It is against this background that the techniques disclosed herein have been developed.

### SUMMARY

Disclosed herein is a computer-implemented method for coordinating care for a patient. The method includes allowing a patient and a first health care provider to participate in a videoconference with each other in which the first health care provider can access electronic health care records (EHR) related to the patient, and allowing the first health care provider to permit a second health care provider to join in the videoconference and also have access to the patient's EHR. This method is designed to support coordinated telehealth where one health care provider is a behavioral health care provider and the other health care provider is a physical health care provider.

Also disclosed is a computer-based system for facilitating interaction between health care patients and health care providers. The system includes a memory; a processor in operative communication with the memory and operative to execute: a configuration module that receives from a first health care provider a selection of the type of telemedicine services to be provided to patients, and a conferencing module that enables the first health care provider to provide one of the selected types of telemedicine services by: receiving an indication from the first provider that the first provider is ready to be connected in a videoconference with a patient; in response thereto, connecting the videoconference; and receiving an indication from the first provider that the first provider is ready to connect a second provider into the videoconference with the first provider and the patient.

The configuration module may also receive from the first provider a selection of one or more time slots during which patients can book appointments; and wherein the processor may also be operative to execute: a scheduling module that: receives from the patient a request to schedule an appointment for one of the selected types of telemedicine services during one of the time slots selected by the first provider; provides to the patient an indication that the appointment has been scheduled; and provides to the first provider an indication that the appointment has been scheduled.

One of the first provider and the second provider may be a behavioral health care provider and the other may be a physical health care provider. The first provider, the second provider, and the patient may interact with the system and with each other via one or more computer networks. The first provider, second provider, and the patient may interact with the system and with each other via web browsers.

The first provider and the second provider may be able to access patient records during the videoconference. The system may be further operative to allow the first provider and the second provider to supplement the patient records during and after the videoconference. The system may be further operative to allow each of the first provider and the second provider to add indications of the services provided, the diagnosis, and other notes. The system may be further operative to allow each of the first provider and the second provider to add SOAP notes, which include subjective, objective, assessment, and plan.

The scheduling module may be operative to allow the first provider to set a schedule of availability for the first provider. The scheduling module also may be operative to allow the first provider to set types of appointments that are available to be scheduled. The scheduling module also may be operative to allow the first provider to set types of appointments that are available to be scheduled.

The conferencing module may allow the patient to check-in for their appointment and be placed into a virtual waiting room. The scheduling module may be further operative to indicate to the first provider that the second provider is available to participate in the videoconference. The scheduling module may be further operative to re-open a time slot in the first provider's schedule when an appointment is cancelled or when the patient fails to check-in for the appointment.

The system may be further operative to allow either or both of the first provider and the second provider to generate a bill to be sent to the patient for services performed based on their participation in the videoconference. The system may further include an interface engine that is used to populate external electronic healthcare records (EHRs). The system may be further operative to encrypt all audio, video, and data signals both as stored and as communicated. The system may be further operative to store all data redundantly to assist in disaster recovery.

In addition to the exemplary aspects and embodiments described above, further aspects and embodiments will become apparent by reference to the drawings and by study of the following descriptions.

### BRIEF DESCRIPTION OF THE DRAWINGS

FIG. 1 is a block diagram illustrating an exemplary hardware architecture of a computing device used in an embodiment of the disclosure herein.

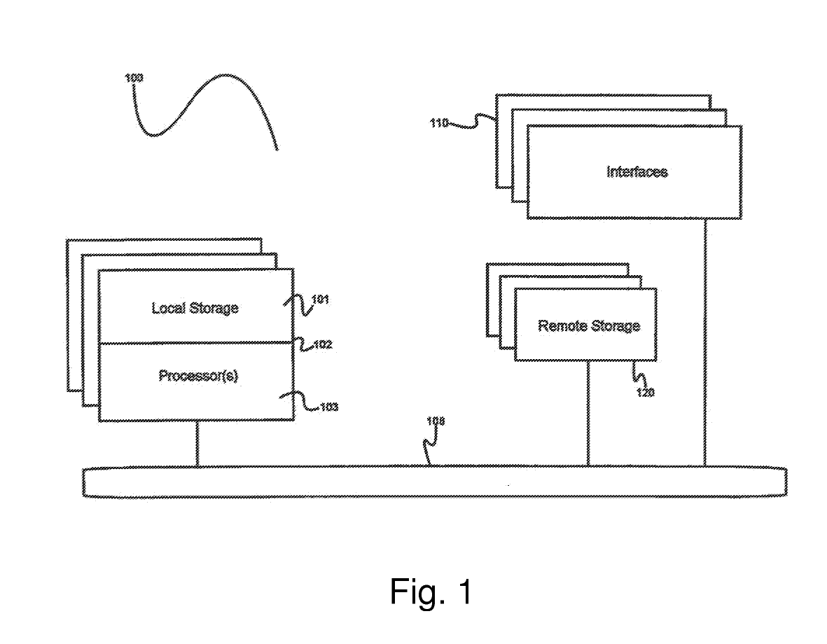

FIG. 2 is a block diagram illustrating an exemplary logical architecture for a client device, according to an embodiment of the disclosure herein.

FIG. 3 is a block diagram illustrating an exemplary architectural arrangement of clients, servers, and external services, according to an embodiment of the disclosure herein.

FIG. 4 provides the highest level view of all components of the multipoint coordinated system for telemedicine delivery including a depiction of multiple potential users.

FIG. 5 details the work flow of a direct care, coordinated telemedicine visit.

FIG. 6 depicts the method through which patients, providers, and administrative support staff manage the scheduling aspect of coordinated care.

FIG. 7 depicts the method through which patients and providers manage the various combinations of interaction needed to coordinate care via teleconsultations.

FIG. 8 depicts data and workspace integration that supports the care integration method.

FIG. 9 includes a screen available to the provider that shows a summary of today's appointments.

FIG. 10 includes a screen available to the provider that allows the provider to manage the different types of appointments that are offered.

### DETAILED DESCRIPTION

While the embodiments disclosed herein are susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives of embodiments of the invention as defined by the claims. The disclosure is described with reference to the drawings, wherein like reference numbers denote substantially similar elements.

The present disclosure generally relates to functionality that may be utilized in taking an originally narrowly defined method and extending it into a non-obvious method to deliver coordinated healthcare across physical and behavioral health within emergent guidelines and quality of care standards.

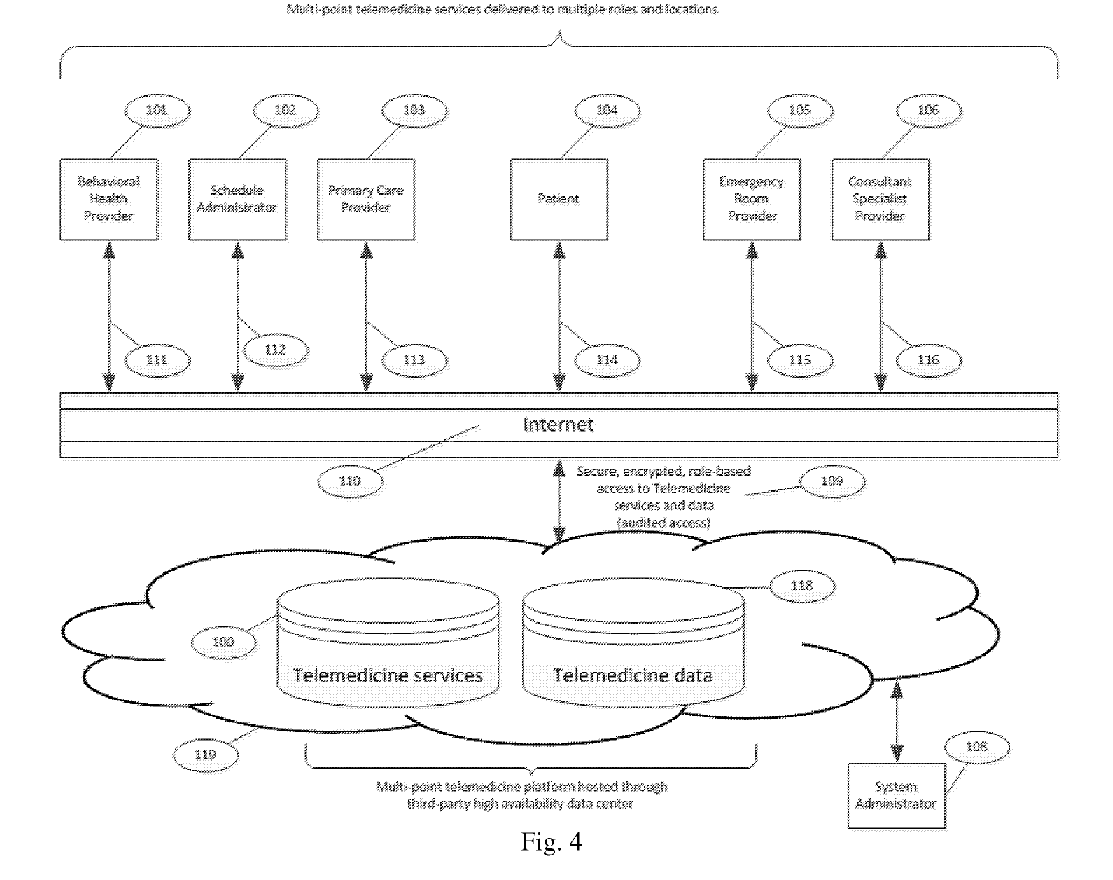

FIG. 4 depicts an overarching view of an internet-based method for facilitating coordinated interaction between health care patients and health care providers. The method supports concurrent use by multiple Patients 104, Behavioral Healthcare Providers (BHPs) 101, Primary Care Physicians (PCPs) 103, Consultant Specialist Providers 106, and Emergency Room/Emergency Department Providers 105, in addition to System and Schedule Administrators 108 and 102. The method is accessed through user-supplied video, audio, data and internet access 111-116, via standard web browser applications. Any combination of users could be physically co-located, or be distributed across multiple clinical, community, and or home settings. The method can be used for on-demand and scheduled direct patient service delivery, as well as on-demand and scheduled professional consultation by individuals or teams. In this way, the method allows for team based treatment that is synchronous, meaning all needed providers collaborate concurrently with the patient, or asynchronously, meaning providers and patients collaborate/access shared data at different time points to contribute to an ongoing care plan integrated across provider(s) and patient. The multi-point, role-based access to shared services and data allows for continuity of care integrated across care teams that could include the patient, patient family, BHPs, PCPs, specialist providers, and care managers. All users have the ability to both send and receive video, voice, and text data through Internet based 110 Applications and Access 111-116. The Telemedicine Service/technology 100 and Telemedicine Data 118 that help support the method are housed in secured, high-availability, virtualized, redundant data centers 119 that both accepts and externally pushes service and Encrypted Data 109 to Internet-based 110 applications.

The Patient 104 is any person to whom health services are being provided, and the patient may initially engage in the method while in the physical presence of a medical or behavioral health provider, at a community-based health center, or individually at any other remote location such as his/her home. For example, during a visit with a primary medical care provider, a patient may disclose to his PCP that she has been experiencing frequent auditory hallucinations and heavy alcohol use. Through the integrated telemedicine method, the PCP 103 could immediately access a behavioral health care colleague 101 and with the Patient 104 still physically present, have a three-way telemedicine appointment to discuss these behavioral health issues, their relationship to physical health issues, such as diabetes, and treatment options, with the patient, and both medical and behavioral providers present.

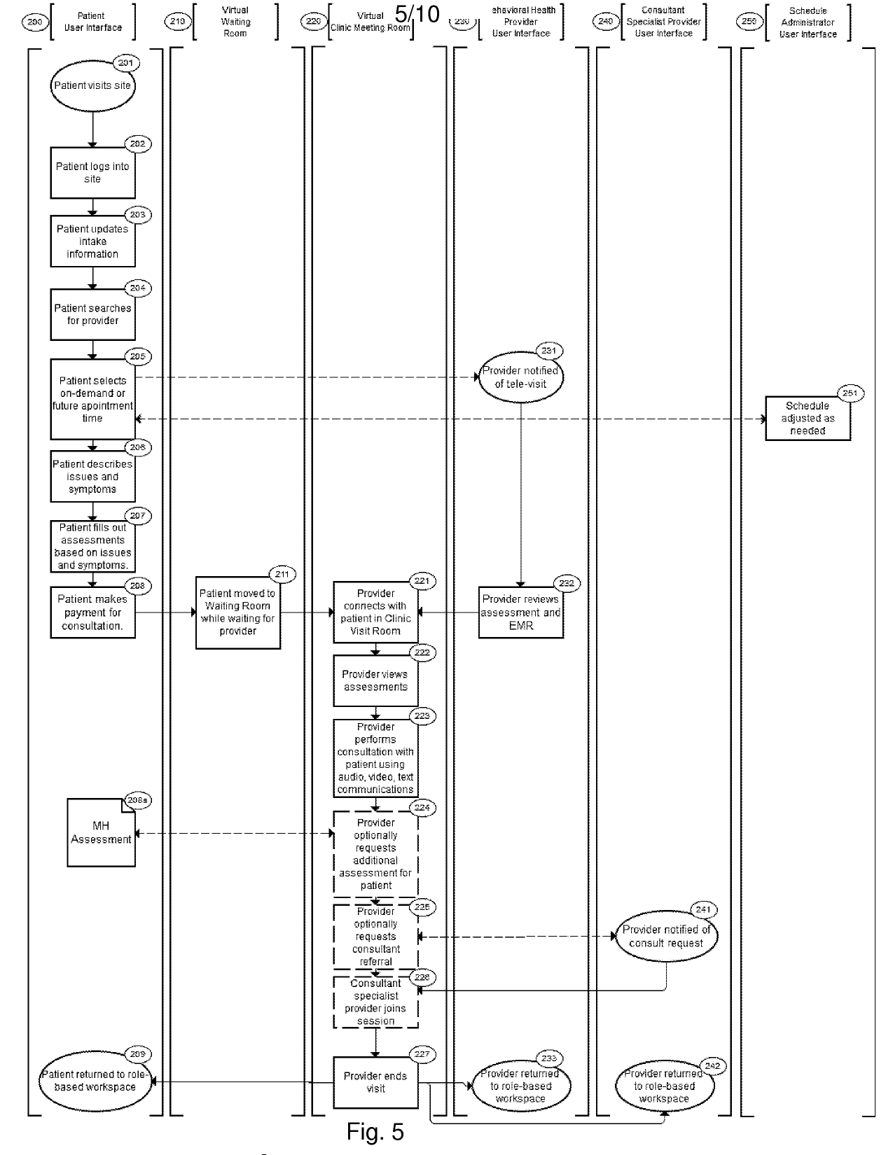

FIG. 5 depicts the method of direct care, integrated patient care delivery. In this method, providers use individual User Interfaces (BHP 230, Specialist 240) to collaborate in the Virtual Clinic/Meeting Room (220) with or without the patient who can be included in this method via the Patient User Interface 200. The Patient's functions (201 through 209) are accessed through this Patient User Interface 200, as the patient Visits the site 201, Logs Into the Site for role-based access to the shared data and services, Updates Intake Information 203, and Searches for Provider 204. Once the Patient Selects an On-Demand or Future Appointment Time 205, the BHP is notified of the on-demand request or confirmed future appointment 231. The appointment times that are available through this function are designated as patient appointment types, and do not compete against appointment times designated for curbside consult appointment types. Schedules are set and updated through the Schedule Administrator User Interface 250 where the administrator can Adjust Schedules as Needed 251. After being confirmed for a televisit, the Patient is transferred to a function to Describe Issues and Symptoms 206, and to Fill Out Assessments Based on those Issues and Symptoms 207. Through a payment function 208 the Patient Makes Payment for Consultation by entering insurance and/or copay, or out of pocket information. Once the Patient has entered the needed information and assessment data, the Patient is Moved to the Virtual Waiting Room while she is waiting for the provider 211.

Once the Provider Reviews Assessment and EMR information 232, she Connects with Patient in the Virtual Clinic/Meeting Room 221. Within the Virtual Clinic 221, providers can access persons, services, and data per role-based permissions, just as in a physical clinical location. Within this space, Providers View Assessment 222 for important symptom information, and has live interaction as the Provider Per-forms Consultation with Colleagues Patient Using Audio, Video, and Text Communication 223. As the visit progresses, the BHP may determine the need for and request Optional Additional Assessment Information224 from the patient. The patient may complete this MH Assessment 208b after the visit back in his/her individual workspace.

Function 225, Provider Optionally Requests Consultant/Referral for Additional Expertise, is for cases where the patient presents with a specific behavioral or physical health issue that can be best addressed by collaboration between the patient, BHP, and a related specialist. Through the Specialist Provider User Interface 240, the specialist Provider is Notified of Consult Request 241, and as the Consultant Specialist Provider Joins the Session 226, she is transferred into the Virtual Clinic/Meeting Room 220 until the Provider ends the visit 227 and all Provider are returned to their role-based workspaces (Patient 209, BHP 232, Specialist 243).

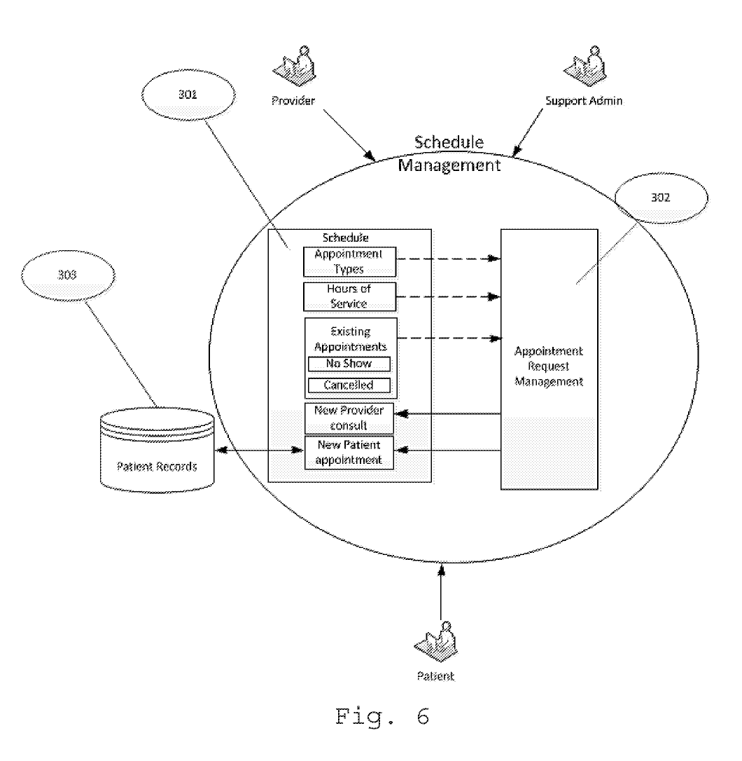

FIG. 6 depicts the method through which patients, providers, and administrative support staff manage the scheduling aspect of coordinated care. Through the Schedule 301 a provider or her/his administrative support can set Hours of Service to indicate appointment availability, and set the Appointment Types that her/his patients and colleagues can request (i.e. 15 minute brief consultation, 30 minute wellness exam, 60 minute psychotherapy, etc.). Through the Schedule 301, the provider can also view her/his schedule of Existing Appointments, and view and accept requests for both Provider Consults and Patient Appointments. Through the Schedule 301, a provider may also link to Patient Record 303 to view information about a patient who has scheduled an appointment. Patients and colleagues who wish to request a meeting with the provider do so through Appointment Request Management 302. Appointment Request Management 302 provides users with a customized view of the provider's availability based on the Hours of Service set by the provider in the Schedule 301, and the Appointment Type selected by the user. For example, a provider may indicate Hours of Service from 10:30 to 11 AM. A user (patient or provider) who selects an appointment type of ‘Assessment, 30 minutes’ would see through Appointment Request Management 302, that open slot at 10:30 AM and be able to schedule herself for the 30 minute window. However, a user who selects an appointment type of ‘Initial Visit, 60 minutes’ would not see the open 10:30-11 AM time slot, or other open time slots that do not meet the minimum duration of the Appointment Type selected. The Schedule 301 pushes information to Appointment Request Management 302, through which, users request specific times and appointment types. It is only once the provider or administrative support person accepts the appointment/consult request, that the appointment or consult is actually scheduled. Accepts can be manual, or can be automated to increase method efficiency in appropriate situations. The real-time capability of this method also contributes to increased care efficiency. When patients or providers miss or ‘no-show’ for scheduled appointments, the provider/administrative support can quickly update the provider's Hours of Availability in the Schedule 301to add an available time slot that can be used for on-demand appointments. This allows patients and colleague providers to request ‘next available’ appointments through the Appointment Request Management 302. Because of high-rates of no-shows in some patient populations, this capability of the computer implemented care coordination method can significantly and positively impact the billable provider hours and the number of patients that can be served.

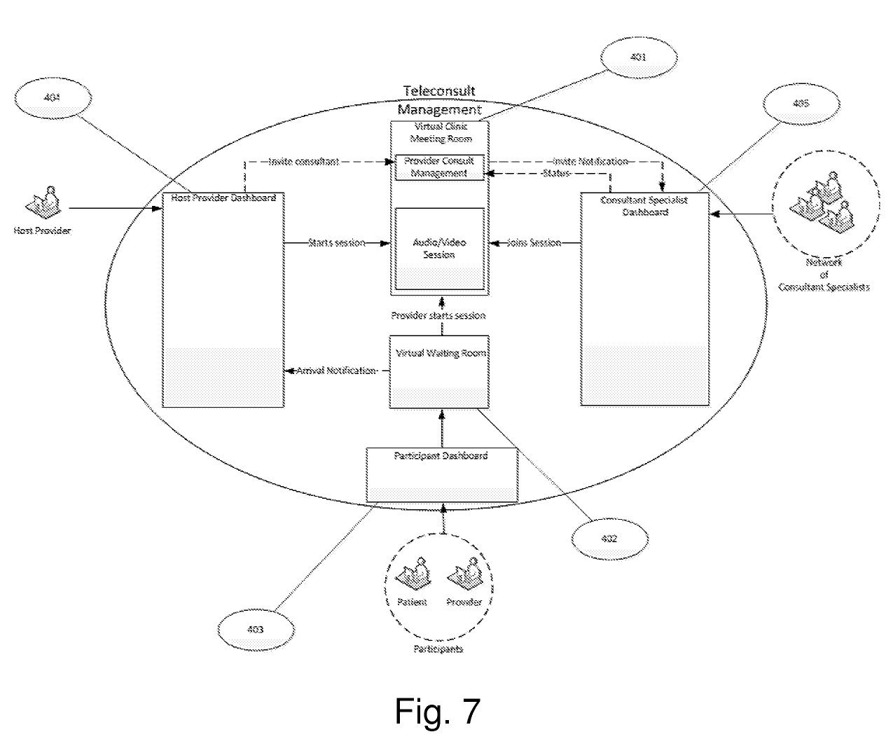

FIG. 7 depicts the method through which patients and providers manage the various combinations of interaction needed to coordinate care via teleconsultations. The depiction includes a designated Host Provider who is accepting patient appointments/colleague provider consults, and making requests of colleague providers as needed. Through the Host Provider Dashboard 404, the Host Provider can: (1) receive an Arrival Notification when a patient or provider participant is in the Virtual Waiting Room 402 for a scheduled or on-demand appointment; (2) Start a Session with any combination of patients/providers moving all participants into the shared Audio-Video Session in the Virtual Clinic Meeting Room 401; (3) Invite a Consultant provider to join a session; and (4) via Provider Consult Management, receive information about a colleague provider's Status (available for consultation or not). The host provider can see the status of any of a pool of providers in the Network of Consultant Specialists so the host has the ability to find one who is available for an on-demand appointment. Prior to, or during the appointment or consult, the Host Provider can request that a second provider from this pool join the appointment/consult through an Invite Notification. Through the Participant Dashboard 403, a non-host participant (colleague provider or patient) prepares for a meeting with the Host Provider, by logging on to the system, and entering the Virtual Waiting Room for an accepted appointment, or on-demand availability. Through the Consultant Specialist Dashboard 405, a provider from the Network of Consultant Specialists can receive an Invite Notification for on-demand or future consult as well as set her/his status (currently available/unavailable for consult) so that the host provider knows which consultants in the network are available in real-time.

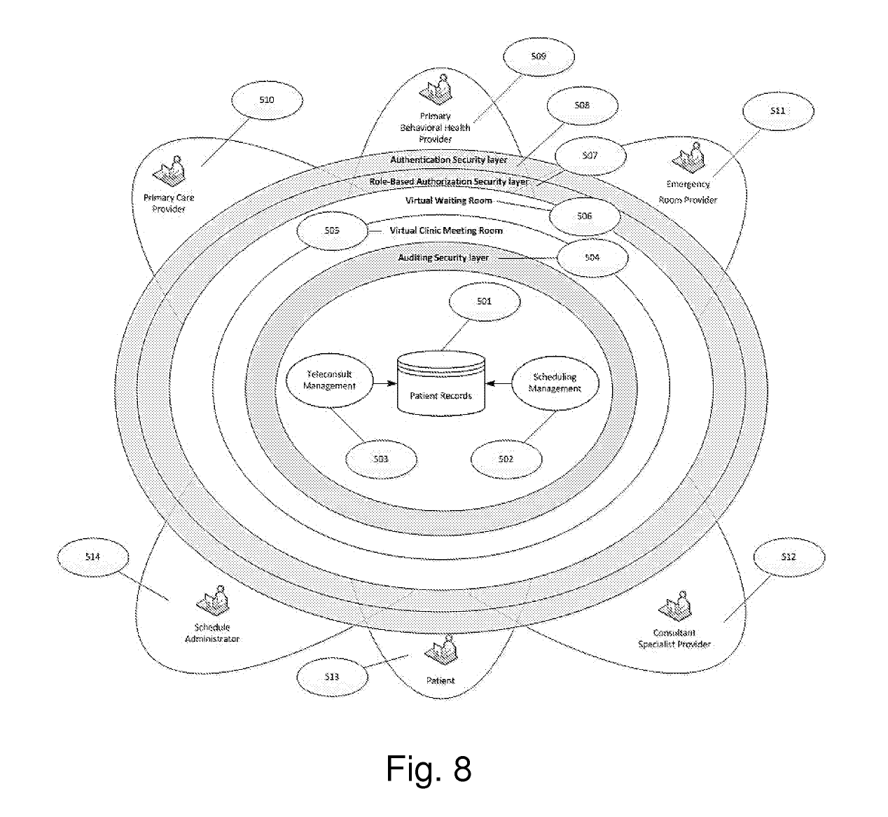

FIG. 8 depicts the way that internet-based data and management processes support care integration across multiple users. Users make additive, role-based modifications to new and or existing integrated health records to maintain an informed care team and support a method of care coordination. Users include a PCP 510, BHP 509, ED Provider 511, Specialty Consultant 512, Patient 513 and Schedule Administrator 514. These users can add-to, but not delete-from an integrated health record that provides a complete picture of interdependent behavioral and physical factors. The Authentication Security Level 508 is responsible for authenticating the user via username, password and/or any future authentication methods, and allows or denies access to the system. The Role-Based Authorization Security Layer 507 further modifies the user experience by determining what services, data, and features each authenticated user is authorized to access and/or modify. Once they've cleared security layers, users move into a Virtual Waiting Room 506, until the host provider (weather primary care, behavioral health, or ED) activates the Virtual Clinic Meeting Room 505. Overlaying this access is the Auditing Security Layer 504 that audits all access to core services and data to track user activities. Attributes such as username, date, time, and what services/data were accessed will be recorded as part of auditing. Through an interface engine, users have role-based access to the Patient Records 501, Teleconsult Management 503 (depicted in more detail in FIG. 7) and Scheduling Management 502 (depicted in more detail in FIG. 6).

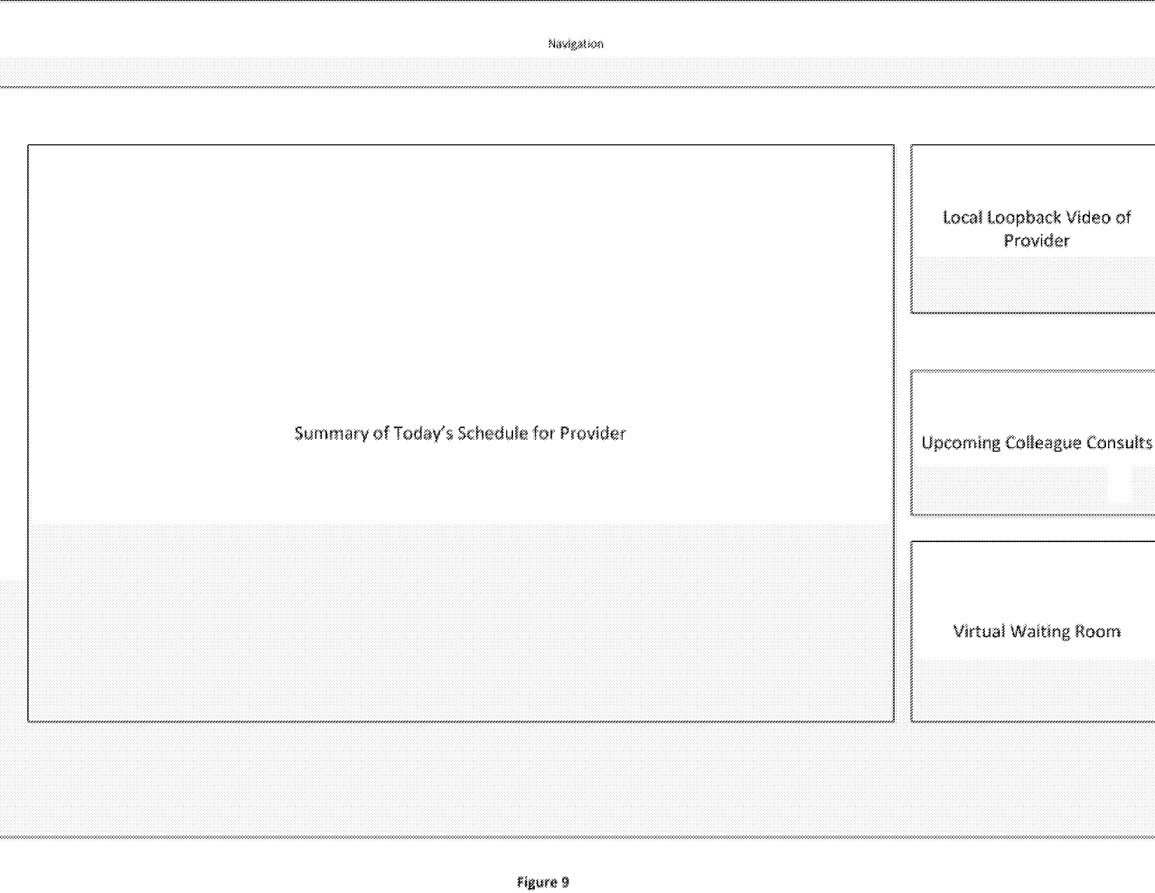

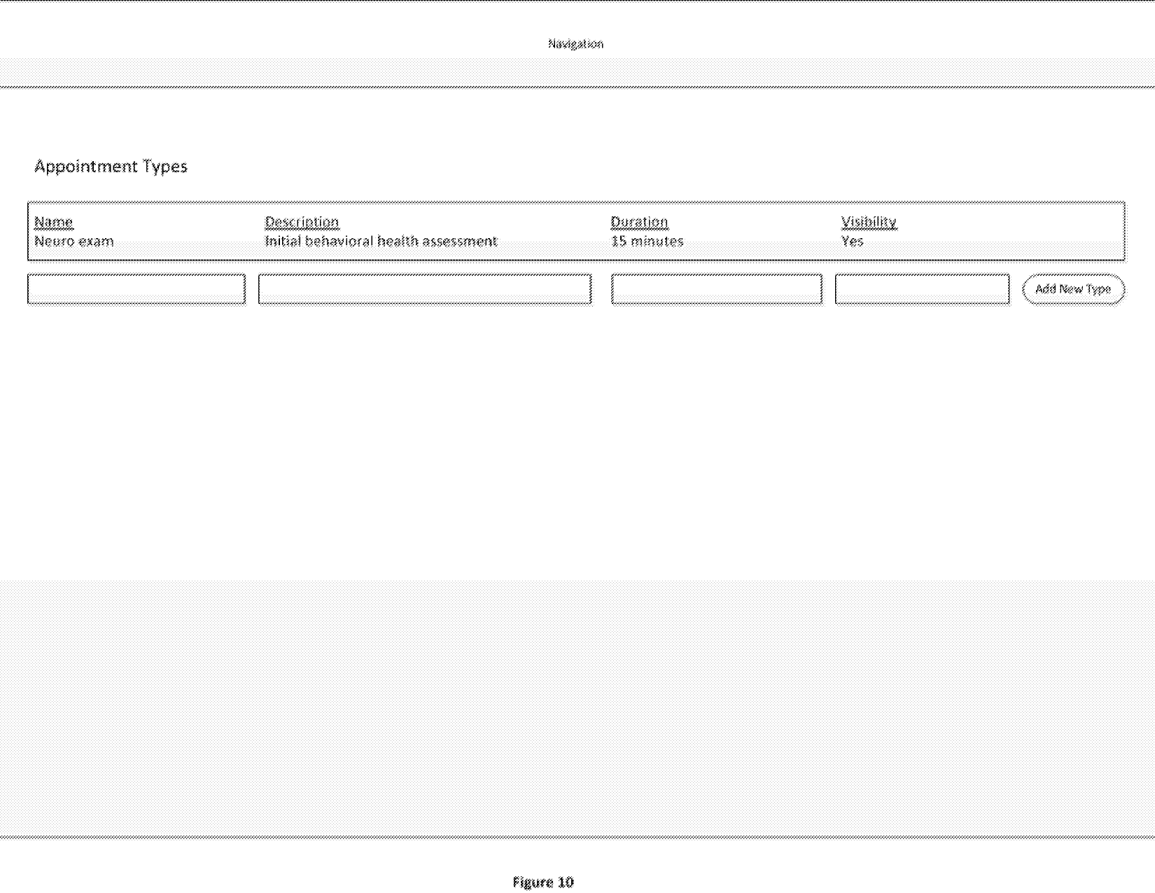

Two block-diagram depicted screen shots from an exemplary implementation of the teachings herein are provided in FIGS. 9-10. It should be understand that these are merely one specific, non-limiting implementation. FIG. 9 includes a screen available to the provider that shows a summary of today's appointments. FIG. 10 includes a screen available to the provider that allows the provider to manage the different types of appointments that are offered.

Many technological advances serve to increase efficiency, effectiveness and specializations, but often with an associated reduction in interpersonal connection. Telephone and email systems advanced the ability to communicate despite distance, but with a sacrifice of important body language cues and context easily delivered and interpreted in person. Skype and other advances now allow for audio and visual communication, but alone, are inefficient additions to already cumbersome processes and practices of health care providers. Further, none of these address the need for whole-person health care and do nothing to enhance collaboration across care types (i.e. physical and behavioral). The disclosed Method for Internet-Facilitated Health Care Coordination makes an important contribution to technology by leveraging technology in new ways that improve the efficiency, effectiveness, and interpersonal collaboration of team-based patient care. Process users can access data/information, and scheduled and on-demand virtual inperson professional consultation through one source; a source that has the new technology to integrate and push information out to all configurations of behavioral and physical health records. In this way, the disclosed method has forwarded technology to make doctors more accessible to patients, to empower patients to take an active role as a critical driving member of their own care teams, and for providers to leverage specialized knowledge through collaborative team-based care, pragmatically, within time and budget limitations. Further, this invention paves the way for future technological advances to enhance distal health assessment (new ways of automating biometric data collection, storage, and interpretation), billing (new ways of conceptualizing and automatically collecting and billing for provider service time) and new ways of providing patient centered care and care access options with reductions in time, travel, pollution, cost, discomfort, and frustration.

At this point, methods and techniques for performing such internet-implemented methods will be discussed. Generally, the techniques disclosed herein may be implemented on any suitable device with any suitable combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a program stored in memory. Such network devices may have multiple network interfaces that may be configured or designed to utilize different types of network communication protocols. A general architecture for some of these machines may be disclosed herein in order to illustrate one or more exemplary means by which a given unit of functionality may be implemented. According to specific embodiments, at least some of the features or functionalities of the various embodiments disclosed herein may be implemented on one or more general-purpose devices associated with one or more networks, such as for example an end-user computer system, a client computer, a network server or other server system, a mobile computing device (e.g., tablet computing device, mobile phone, smartphone, laptop, and the like), a consumer electronic device, a music player, or any other suitable electronic device, router, switch, or the like, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or the like).

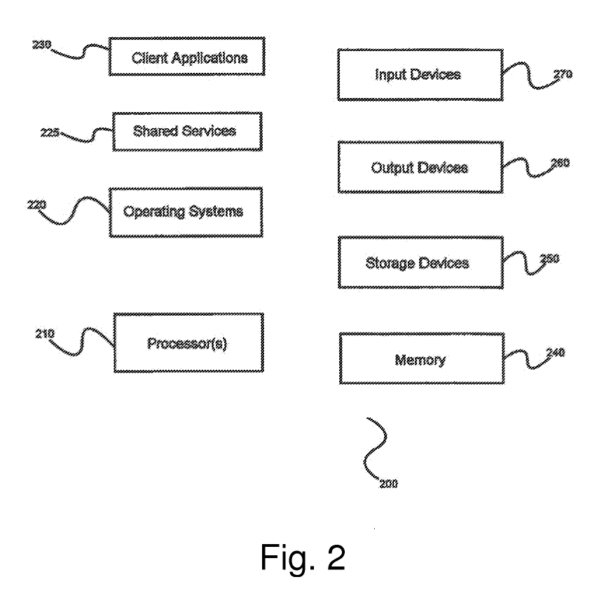

Referring now to FIG. 2, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software-or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110.

In at least one embodiment, CPU 102 may be caused to perform one or more of the different types of functions and/or operations under the control of software modules or components, which for example, may include an operating system and any appropriate applications software, drivers, and the like. CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, Firewire™, PCI, parallel, radio frequency (RF), Bluetooth™ near-field communications (e.g., using near-field magnetics), 802.11 (WiFi), frame relay, TCP/IP, ISDN, fast Ethernet interfaces, Gigabit Ethernet interfaces, asynchronous transfer mode (ATM) interfaces, highspeed serial interface (HSSI) interfaces, Point of Sale (POS) interfaces, fiber data distributed interfaces (FDDIs), and the like. Generally, such interfaces 110 may include ports appropriate for communication with appropriate media. In some cases, they may also include an independent processor and, in some in stances, volatile and/or non-volatile memory (e.g., RAM).

Although the system shown in FIG. 2 illustrates one specific architecture for a computing device 100 for implementing one or more of the embodiments described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system that includes a client device (such as a tablet device or smartphone running client software) and server systems (such as a server system described in more detail below).

Regardless of network device configuration, the system may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory, solid state drives, memristor memory, random access memory (RAM), and the like. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the device using an interpreter (for example, scripts written in Python, Perl, Ruby, Groovy, or any other scripting language).

In some embodiments, systems may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments, such as for example a client application 230. Processors 210 may carry out computing instructions under control of an operating system 220 such as, for example, a version of Microsoft's Windows™ operating system, Apple's Mac OS/X or iOS operating systems, some variety of the Linux operating system, Google's Android™ operating system, or the like. In many cases, one or more shared services 225 may be operable in system 200, and may be useful for providing common services to client applications 230. Services 225 may for example be Windows™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form. Examples of storage devices 250 include flash memory, magnetic hard drive, CD-ROM, and/or the like.

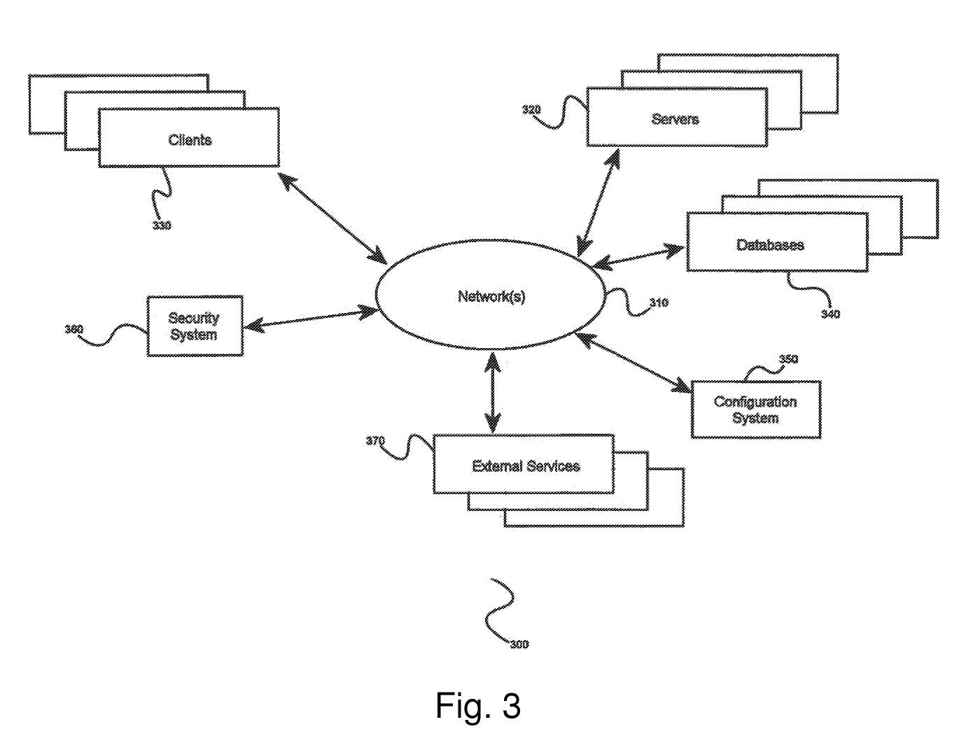

In some embodiments, systems may be implemented on a distributed computing network, such as one having any number of clients and/or servers. Referring now to FIG. 3, there is shown a block diagram depicting an exemplary architecture for implementing at least a portion of a system according to an embodiment on a distributed computing network. According to the embodiment, any number of clients 330 may be provided. Each client 330 may run software for implementing client-side portions of the embodiments and clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network, a wireless network (such as WiFi, Wimax, and so forth), or a local area network (or indeed any network topology known in the art; no one network topology is preferred over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise internet-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments, clients 330 or servers 320 (or both) may make use of one or more specialized services or appliances that may be deployed locally or remotely across one or more networks 310. For example, one or more databases 340 may be used or referred to by one or more embodiments. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments may make use of one or more security systems 360 and configuration systems 350. Security and configuration management are common information technology (IT) and internet functions, and some amount of each are generally associated with any IT or internet systems. It should be understood by one having ordinary skill in the art that any configuration or security subsystems known in the art now or in the future may be used in conjunction with embodiments without limitation, unless a specific security 360 or configuration system 350 or approach is specifically required by the description of any specific embodiment.

In various embodiments, functionality for implementing systems or methods may be distributed among any number of client and/or server components. For example, various software modules may be implemented for performing various functions, and such modules can be variously implemented to run on server and/or client components.

Any of the embodiments, arrangements, or the like discussed herein may be used (either alone or in combination with other embodiments, arrangement, or the like) with any of the disclosed aspects. Merely introducing a feature in accordance with commonly accepted antecedent basis practice does not limit the corresponding feature to the singular. Any failure to use phrases such as “at least one” does not limit the corresponding feature to the singular. Use of the phrase “at least generally,” “at least partially,” “substantially” or the like in relation to a particular feature encompasses the corresponding characteristic and insubstantial variations thereof. Furthermore, a reference of a feature in conjunction with the phrase “in one embodiment” does not limit the use of the feature to a single embodiment.

While this specification contains many specifics, these should not be construed as limitations on the scope of the disclosure or of what may be claimed, but rather as descriptions of features specific to particular embodiments of the disclosure. Furthermore, certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software and/or hardware product or packaged into multiple software and/or hardware products.

The above described embodiments including the preferred embodiment and the best mode of the invention known to the inventor at the time of filing are given by illustrative examples only.

1. A computer-implemented method for coordinating care for a patient, the method comprising:
allowing a patient and a first health care provider to participate in a videoconference with each other in which the first health care provider can access electronic health care records (EHR) related to the patient, and
allowing the first health care provider to permit a second health care provider to join in the videoconference and also have access to the patient's EHR;
wherein one of the first health care provider and the second health care provider is a behavioral health care provider and the other health care provider is a physical health care provider.

2. A computer-based system for facilitating interaction between health care patients and health care providers, comprising:
a memory;
a processor in operative communication with the memory and operative to execute:
a configuration module that receives from a first health care provider a selection of the type of telemedicine services to be provided to patients, and
a conferencing module that enables the first health care provider to provide one of the selected types of telemedicine services by:
receiving an indication from the first provider that the first provider is ready to be connected in a videoconference with a patient;
in response thereto, connecting the videoconference; and
receiving an indication from the first provider that the first provider is ready to connect a second provider into the videoconference with the first provider and the patient.

3. A system as defined in claim 2, wherein the configuration module also receives from the first provider a selection of one or more time slots during which patients can book appointments; and
wherein the processor also is operative to execute:
a scheduling module that:
receives from the patient a request to schedule an appointment for one of the selected types of telemedicine services during one of the time slots selected by the first provider;
provides to the patient an indication that the appointment has been scheduled; and
provides to the first provider an indication that the appointment has been scheduled.

4. A system as defined in claim 2, wherein one of the first provider and the second provider is a behavioral health care provider and the other is a physical health care provider.

5. A system as defined in claim 2, wherein the first provider, the second provider, and the patient interact with the system and with each other via one or more computer networks.

6. A system as defined in claim 2, wherein the first provider, second provider, and the patient interact with the system and with each other via web browsers.

7. A system as defined in claim 2, wherein the first provider and the second provider are able to access patient records during the videoconference.

8. A system as defined in claim 2, wherein the system is further operative to allow the first provider and the second provider to supplement the patient records during and after the videoconference.

9. A system as defined in claim 8, wherein the system is further operative to allow each of the first provider and the second provider to add indications of the services provided, the diagnosis, and other notes.

10. A system as defined in claim 9, wherein the system is further operative to allow each of the first provider and the second provider to add SOAP notes, which include subjective, objective, assessment, and plan.

11. A system as defined in claim 2, wherein the scheduling module is operative to allow the first provider to set a schedule of availability for the first provider.

12. A system as defined in claim 11, wherein the scheduling module is also operative to allow the first provider to set types of appointments that are available to be scheduled.

13. A system as defined in claim 2, wherein the scheduling module is also operative to allow the first provider to set types of appointments that are available to be scheduled.

14. A system as defined in claim 2, wherein the conferencing module allows the patient to check-in for their appointment and be placed into a virtual waiting room.

15. A system as defined in claim 2, wherein the scheduling module is further operative to indicate to the first provider that the second provider is available to participate in the videoconference.

16. A system as defined in claim 2, wherein the scheduling module is further operative to re-open a time slot in the first provider's schedule when an appointment is cancelled or when the patient fails to check-in for the appointment.

17. A system as defined in claim 2, wherein the system is further operative to allow either or both of the first provider and the second provider to generate a bill to be sent to the patient for services performed based on their participation in the videoconference.

18. A system as defined in claim 2, wherein the system further includes an interface engine that is used to populate external electronic healthcare records (EHRs).

19. A system as defined in claim 2, wherein the system is further operative to encrypt all audio, video, and data signals both as stored and as communicated.

20. A system as defined in claim 2, wherein the system is further operative to store all data redundantly to assist in disaster recovery.
